(19) United States
(12) Patent Application Publication
(10) Pub. No.: US 2022/0385552 A1
(43) Pub. Date: Dec. 1, 2022

(54) RECORD AND REPLAY NETWORK TRAFFIC

(71) Applicant: AT&T Intellectual Property I, L.P., Atlanta, GA (US)

(72) Inventors: Sridhar Narahari, Milpitas, CA (US); John F. Gibbons, Ballston Lake, NY (US); Michael Satterlee, Clifton Park, NY (US)

(21) Appl. No.: 17/332,489

(22) Filed: May 27, 2021

(51) Int. Cl. H04L 12/26; H04L 12/24

(52) U.S. Cl. CPC H04L 43/0817; H04L 43/0882; H04L 43/062; H04L 41/082

(57) ABSTRACT

Architectures and techniques are presented that record bi-directional traffic flows of a network such as a software defined network, that result from execution of a specified application. This recorded traffic data can be generated prior to a network change and can be anonymized in various ways to maintain security and privacy. After applying the network change, the traffic data can be replayed to test performance of the specified application in a manner that realistically represents actual use of the specified application.

### TECHNICAL FIELD

The present application relates generally to record techniques that can record elements of network traffic e.g., between network edges and replay techniques that can play back the network traffic in a manner that simulates the original traffic.

### BACKGROUND

Network providers provide network services, such as routing customer traffic efficiently. When the network is upgraded, it is possible that applications executed at customer devices do not function as expected. Modern networks providers commonly rely on testing techniques to determine whether a given network upgrade will affect customer demands Current testing techniques may have limitations that can be overcome.

### BRIEF DESCRIPTION OF THE DRAWINGS

Numerous aspects, embodiments, objects and advantages of the present application will be apparent upon consideration of the following detailed description, taken in conjunction with the accompanying drawings, in which like reference characters refer to like parts throughout, and in which:

FIG. 1 depicts a block diagram of an example device that can perform a record procedure that can record application flows from a specific application in accordance with certain embodiments of this disclosure;

FIG. 2 shows a schematic diagram of a system illustrating an embodiment in which the record procedure is implemented in an SDN in accordance with certain embodiments of this disclosure;

FIG. 3 illustrates a schematic diagram of an example system illustrating additional aspects or elements of the recording procedure in accordance with certain embodiments of this disclosure;

FIG. 4 illustrates a block diagram of an example device that can perform a replay procedure that can replay application flows from a specific application in accordance with certain embodiments of this disclosure;

FIG. 5 shows a schematic diagram of a system illustrating an embodiment in which the playback procedure is implemented in an SDN in accordance with certain embodiments of this disclosure;

FIG. 6 illustrates an example method that can perform a record procedure that can record application flows from a specific application in accordance with certain embodiments of this disclosure;

FIG. 7 illustrates an example method that can provide for additional elements or aspects in connection with the record procedure that can record application flows from a specific application in accordance with certain embodiments of this disclosure;

FIG. 8 illustrates a first example of a wireless communications environment with associated components that can be operable to execute certain embodiments of this disclosure;

FIG. 9 illustrates a second example of a wireless communications environment with associated components that can be operable to execute certain embodiments of this disclosure; and

FIG. 10 illustrates an example block diagram of a computer operable to execute certain embodiments of this disclosure.

### DETAILED DESCRIPTION

### Overview

Network subscribers or customers execute a variety of applications that generate network traffic in the form of application flows. These applications can range from voice applications to payment applications and many others. Customers have an expectation that when the network is upgraded the upgraded network can handle customer flows in a satisfactory way. Unfortunately, some network upgrades (e.g., new code, configuration updates, and so on) can lead to unexpected issues with certain applications or the associated application flows. If these applications are critical to the customer or frequently utilized by the customer, then substantial dissatisfaction can arise.

The above situation applies to potentially any type of network, but with the advent and development of software defined networks (SDN), network technology has advanced significantly by providing application/performance based routing. However, networking technologies at large do not provide a simple way to check whether a specific application will operate successfully or at a desired performance level following a network upgrade. In the past, the process to validate an updated network relied on general network or traffic tests that are typically performed in a laboratory setting (e.g., a testing environment). However, because there was no way to easily replicate actual flows corresponding to specific applications that the customer uses, such testing has only included testing of generic classes of applications (e.g., TCP application or the like). Post upgrade production testing (e.g., in a production environment) might also be performed, but such was typically limited to general network health checks and therefore incapable of testing the operation of specific applications used by a customer.

In other words, previous techniques were potentially useful in verifying the general function of a network after an update, but did not directly validate the impact of a network update on specific applications. Traffic generation utilities can be used during pre-production testing but are not necessarily a good solution to simulate the ability of the network to support specific applications. Moreover, these utilities can be expensive as they require additional boxes that are difficult to deploy at many sites. Further, customers often use applications with specific behavior in terms of how the traffic is handled by the network. For example, an application can set header fields and options in a very specific way, which can affect the ability of the network to support both connections and performance.

The disclosed subject matter relates to building in a record and replay function within the network, to facilitate testing of specific applications following a network upgrade or change. Such techniques can allow export of flows to facilitate pre-production testing of captured flows in a test environment. The disclosed techniques can then enact a distributed record and replay function that captures and retains the original timing of packets during replay, to replicate the original application flow through the network. Headers can be anonymized and the user's payload can be replaced with dummy date as part of the record function to remove any privacy issues. This approach does not rely on additional equipment or action from any users attached to the network which can add quick value to network operators, for instance, by allowing the network operator to proactively test recorded customer application flows after a network upgrade or change. Value can be added to users as well via a user friendly design. The techniques detailed herein can also provide an improvement over purpose built packet generation devices in terms of the ability to validate that the network can handle the specifics of the applications in a satisfactory way, and also in terms of cost.

### Example Systems

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

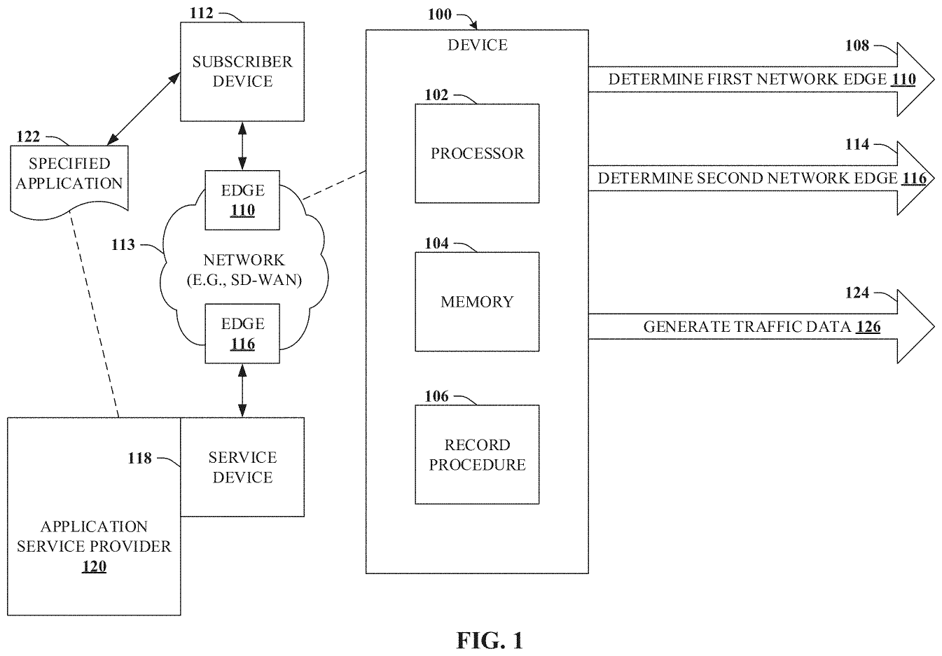

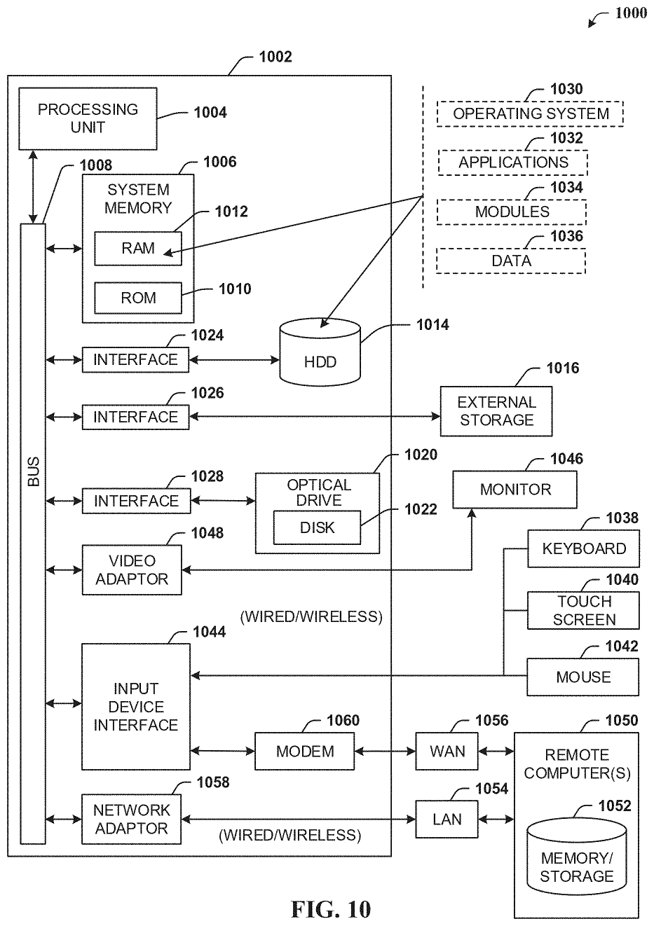

Referring now to FIG. 1, device 100 is depicted. Device 100 can perform a record procedure that can record application flows from a specific application in accordance with certain embodiments of this disclosure. Device 100 can comprise a processor 102 that can be specifically configured to perform the record procedure 106 and a memory 104 that stores executable instructions that, when executed by the processor, facilitate performance of operations. Device 100 can comprise record procedure 106 component or circuit that can be specifically tailored to perform recording operations. Processor 102 can be a hardware processor having structural elements known to exist in connection with processing units or circuits, with various operations of processor 102 being represented by functional elements shown in the drawings herein that can require special-purpose instructions, for example stored in memory 104 and/or record procedure 106 component or circuit. Along with these special-purpose instructions, processor 102 and/or device 100 can be a special-purpose device. Further examples of the memory 104 and processor 102 can be found with reference to FIG. 10. It is to be appreciated that device 100 or computer 1002 can represent a server device of a communications network or a user equipment device and can be used in connection with implementing one or more of the systems, devices, or components shown and described in connection with FIG. 1 and other figures disclosed herein.

In response to execution of the executable instructions stored to memory 104, Device 100 can determine first network edge 110, which is illustrated by determination 108. First network edge 110 can represent a device or equipment that facilitates network access to a subscriber device 112 or equipment. In some embodiments, network 113 can be a software defined network (SDN) such as, for example, an SD wide area network (SD-WAN). As illustrated at reference numeral 114, device 100 can determine second network edge 116. Second network edge 116 can represent a device or equipment that facilitates network access to service device 118 associated with an application service provider 120. Traffic can flow between subscriber device 112 and service device 118 in response to subscriber device 112 executing specified application 122 that is associated with application service provider 120. In some embodiments, service device 118 can be a third party device or a device of a different subscriber (potentially also executing specified application 122), where the traffic generated between subscriber device 112 and service device 120 results from execution of specified application 122.

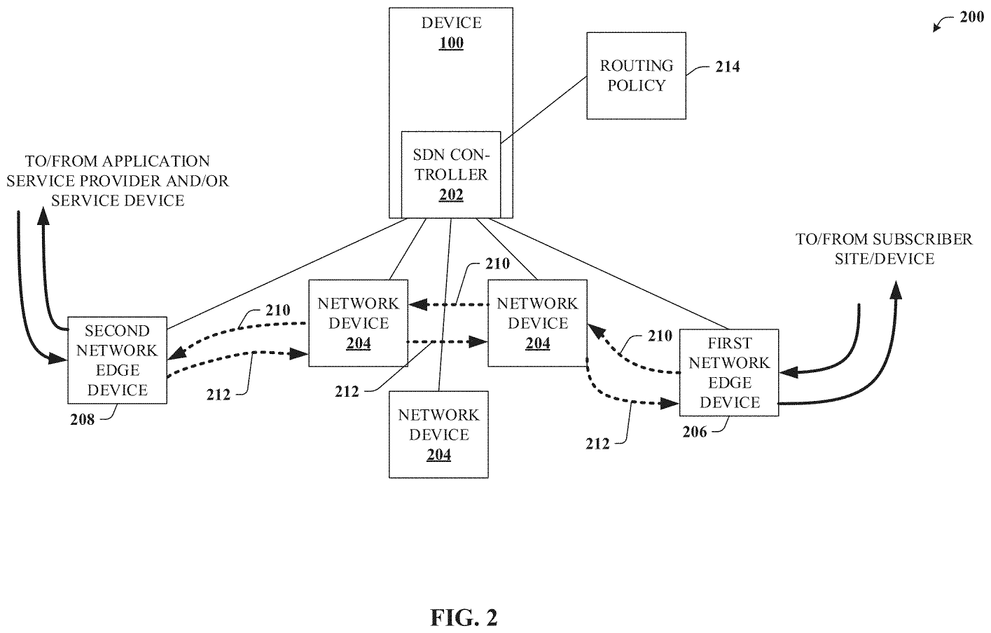

At reference numeral 124, device 100 can generate traffic data 126. Traffic data 126 can be indicative of a record of bi-directional traffic flows between first network edge 110 and second network edge 116. This record of bi-directional traffic flows can result from subscriber device 112 executing specified application 122 that is associated with application service provider 120. Such is further illustrated in connection with FIG. 2.

While still referring to FIG. 1, but turning now as well to FIG. 2, a schematic diagram of system 200 is depicted. System 200 illustrates an embodiment in which the record procedure is implemented in an SDN in accordance with certain embodiments of this disclosure. In this example, device 100 can be or can include SDN controller 202. SDN controller can control numerous network devices 204, including first network edge device 206 and second network edge device 208. When a subscriber device 120 or site executes specified application 122, traffic is generated between a data source (e.g., subscriber device 112) and a data target (e.g., service device 118). This traffic enters network 113 at first network edge device 206, follows network paths illustrated by paths 210, and exits network 113 at second network edge device 208. A response can be issued, which generates additional traffic that flows in the opposite direction from the service side to the subscriber side, illustrated by paths 212.

SDN controller 202 can identify first network edge device 206 and second network edge device 208 based on routing policy 214 and, for instance, a proximity to the source and the target. Routing policy 214 can further be employed to determine bi-direction paths 210, 212, which can be used to generate traffic data 126. For example, SDN controller 202 can initially identify first network edge device 206 and second network edge device 208. SDN controller 202 can instruct second network edge device 208 to record traffic flows from first network edge device 206, which flow according to paths 210. SDN controller 202 can likewise instruct first network edge device 206 to record traffic flows from second network edge device 208, which flow according to paths 212. SDN controller 202 can receive and combine both of these traffic flows, resulting in the bi-directional traffic flows recorded by traffic data 126. It is appreciated that record (and replay, detailed below) can be distributed functions. For example these functions can be executed on both edges 206, 208 that record or replay the direction of the flow where they are nearest to the source/target.

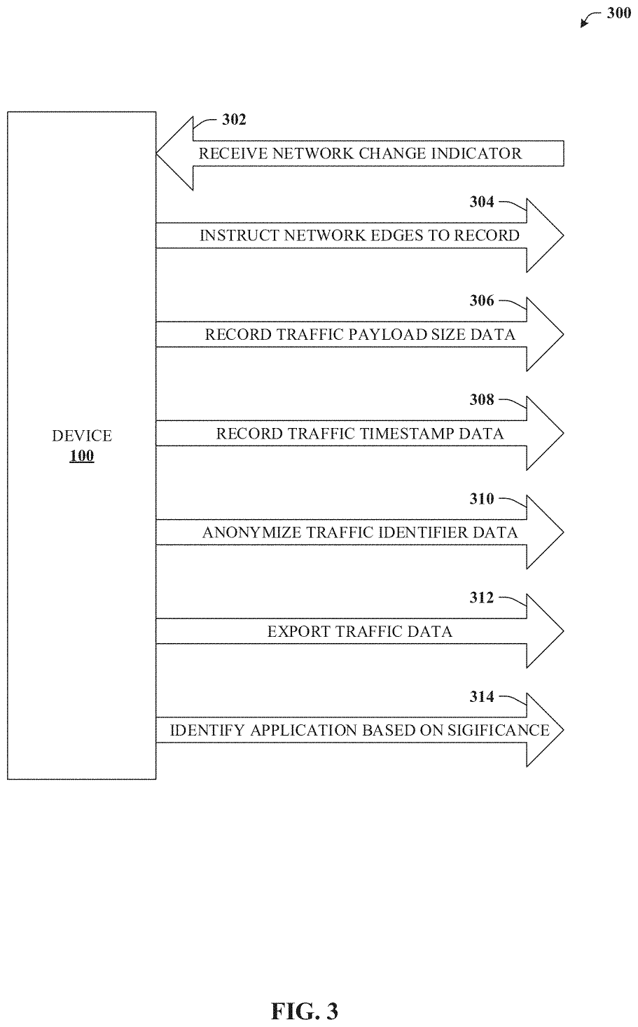

Referring now to FIG. 3, a schematic diagram of system 300 is depicted. System 300 illustrates additional aspects or elements of the recording procedure in accordance with certain embodiments of this disclosure. For example, at reference numeral 302, device 100 can receive a network change indicator. This network change indicator can indicate that a change or update to network 113 is planned or otherwise expected. In some embodiments, initiation of the record procedure that generates traffic data 126 can be in response to receiving an indication that network 113 is to undergo an upgrade that is determined to affect operation of specified application 122.

Hence, for example, SDN controller 202 can instruct network edge devices 206, 208 to record appropriate traffic flows, as illustrated by reference numeral 304. Actual data payload that transferred is propagated by these application flows need not be used. Rather, such can be replaced with dummy or generic data, which can help to mitigate privacy or security concerns. Thus, traffic data 126 can comprise payload size data that can be indicative of a size of payload data of the bi-directional traffic flows, which is illustrated at reference numeral 306. When the bi-directional traffic flows are subsequently replayed (e.g., to test performance of the upgraded network with respect to specified application 122), the same data payload sizes can be used.

Traffic data 126 can further comprise timestamp data, which is illustrated at reference numeral 308. This timestamp data can be stored as metadata and can be indicative of timing applicable to the bi-directional traffic flows. At reference numeral 310, device 100 can further anonymize traffic identifier data. For example, identifier commonly found in headers or the like can be replaced with anonymized identifier data. In other words, any information that relates to an identity of either the source or the target or associated devices can be removed or replaced. Replacing such data with anonymized data can be in accord with any suitable algorithm that does not substantially alter operation of the replayed flows.

At reference numeral 312, traffic data 126 can be exported. For instance, traffic data 126 can be configured as an exportable file. Hence, traffic data can be imported by different network instances and/or to any testing or production environment. Such can be particularly advantageous in connection with testing and/or replaying the bi-direction traffic flows recorded by traffic data 126 in order to determine performance of specified application in a post-upgrade environment.

It is understood that while the techniques detailed herein can potentially be applied to all applications used by any subscriber, in some embodiments, the disclosed techniques can be applied to a subset of the applications used by subscribers. For example, application-specific testing can be performed only with respect to critical or significant applications of the subscriber. In other words, the application(s) (e.g., specified application 122) selected for testing can be selected or identified based on a significance determination, which is indicated at reference numeral 314. Put differently, specified application can be determined in response to identifying a target application having at least a determined significance according to a defined significance criterion. In some embodiments, subscriber input can be used (e.g., a subscriber selects applications that are important or significant). In some embodiments, the specified application can be identified in an intelligent manner such as the significance criterion reflecting, e.g., frequency of use, percentage of network use, type of application or the like.

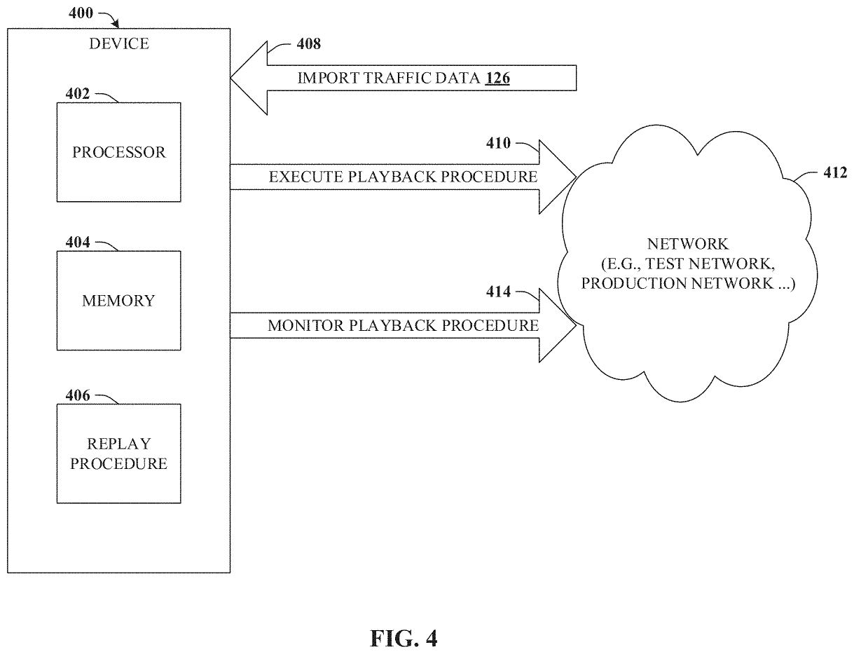

Turning now to FIG. 4, device 400 is illustrated. Device 400 can perform a replay procedure that can replay application flows from a specific application in accordance with certain embodiments of this disclosure. Device 400 can comprise a processor 402 that can be specifically configured to perform the replay procedure 406 and a memory 404 that stores executable instructions that, when executed by the processor, facilitate performance of operations. Device 400 can comprise replay procedure 406 component or circuit that can be specifically tailored to perform replay operations. Processor 402 can be a hardware processor having structural elements known to exist in connection with processing units or circuits, with various operations of processor 402 being represented by functional elements shown in the drawings herein that can require special-purpose instructions, for example stored in memory 404 and/or record procedure 406 component or circuit. Along with these special-purpose instructions, processor 402 and/or device 400 can be a special-purpose device. Further examples of the memory 404 and processor 402 can be found with reference to FIG. 10. It is to be appreciated that device 400 or computer 1002 can represent a server device of a communications network or a user equipment device and can be used in connection with implementing one or more of the systems, devices, or components shown and described in connection with FIG. 4 and other figures disclosed herein.

As illustrated at reference numeral 408, device 400 can import traffic data 126. In some embodiments, such can be in response to a determination that a network upgrade has been performed. In other words, traffic data 126 can be imported to a network environment (e.g., network 412) to which the network upgrade has been applied. Network 412 can be a testing environment or a post production environment and device 400 can be a part of network 412 such as a function portion of an associated SDN controller. Hence, while network 113 is intended to represent a network prior to the upgrade procedure and where application flows are recorded, network 412 can represent the network after the upgrade so that performance of application flows of specified application 122 can be tested or compared to benchmarks or other expectations.

At reference numeral 410, device 400 can execute playback procedure 410 (potentially controlled by replay procedure 406 component or circuit). This playback procedure can instruct first network edge device 206 and second network edge device 208 to play back the bi-direction traffic flows indicated by traffic data 126. As noted, the replaying can be anonomized, but payload data size, timing and other elements recorded during the record procedure can be the same or similar.

At reference numeral 414, the playback procedure can be monitored. For example, monitoring of the playback procedure can used to determine whether the network upgrade changes a performance of specified application 122 relative to a previous performance of specified application 122 measure prior to the network upgrade. In some embodiments, the performance of specified application 122 can be relative to a defined performance benchmark or performance threshold.

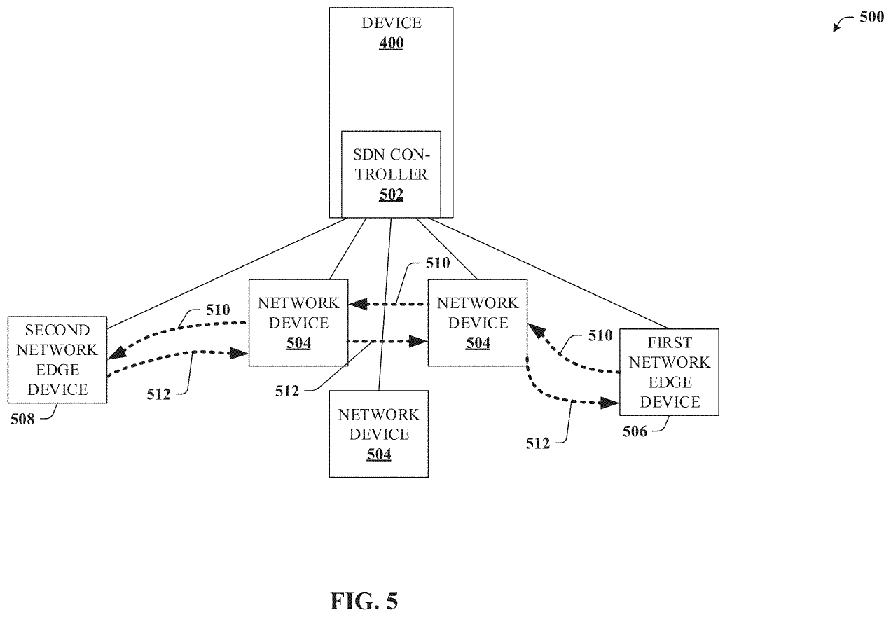

While still referring to FIG. 4, but turning now as well to FIG. 5, a schematic diagram of system 500 is depicted. System 500 illustrates an embodiment in which the playback procedure is implemented in an SDN in accordance with certain embodiments of this disclosure. In this example, device 400 can be or can include SDN controller 502. SDN controller 502 can control numerous network devices 504, including first network edge device 506 and second network edge device 508.

Upon importing traffic data 126, SDN controller 502 can instruct first network edge device 506 to replay recorded traffic flows illustrated by paths 510. SDN controller 502 can likewise instruct second network edge device 508 to replay recorded traffic flows illustrated by paths 512. As noted, both timing and payload data size for every packet can be in accord with what was previously recorded during the record procedure. Generic and/or dummy data constructed for packet payload can be determined during the record procedure or the playback procedure, but in either case original payload data is not stored. Generic, dummy, and/or anonymized header data can likewise be generated during the record procedure or the playback procedure, but in either case, the original header data is not stored.

Metadata or other data can be saved for recorded flows along with the anonymized flows themselves, representing traffic data 126. Thus, traffic data 126 can enable playback and export, which can be useful for export to a test environment. Such can make it possible to do a simple, realistic test of actual application flows that have been anonymized but with L3-L7 headers intact within the test environment.

### Example Methods

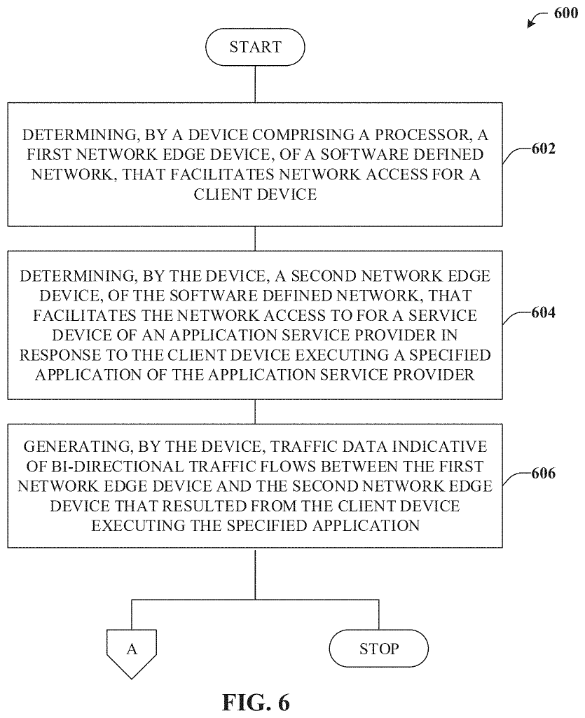

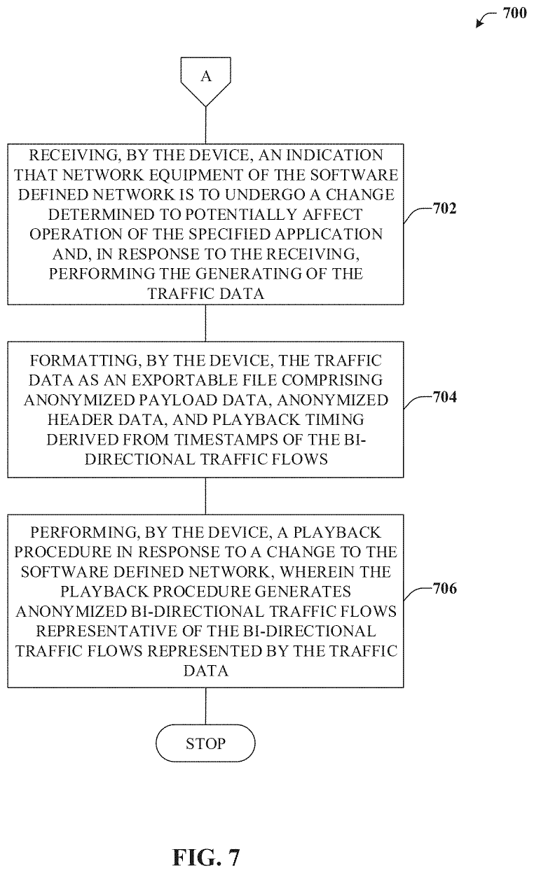

FIGS. 6 and 7 illustrate various methodologies in accordance with the disclosed subject matter. While, for purposes of simplicity of explanation, the methodologies are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the disclosed subject matter. Additionally, it should be further appreciated that the methodologies disclosed hereinafter and throughout this specification are capable of being stored on an article of manufacture to facilitate transporting and transferring such methodologies to computers.

Turning now to FIG. 6, exemplary method 600 is depicted. Method 600 can perform a record procedure that can record application flows from a specific application in accordance with certain embodiments of this disclosure. For example, at reference numeral 602, a device comprising a processor can determine a first network edge device, of a SDN, that facilitates network access for a client device. The first network edge device can be one that is determined to be nearest or proximal to the client device. In some embodiments, the first network edge device can be determined by an SDN controller of the SDN, for instance based on routing policies of the SDN or the like.

At reference numeral 604, the device can determine a second network edge device, of the SDN, that facilitates the network access to for a service device of an application service provider in response to the client device executing a specified application of the application service provider. The second network edge device can be determined to be nearest or proximal to the service device. In some embodiments, the second network edge device can be determined by an SDN controller of the SDN, for instance based on routing policies of the SDN or the like.

At reference numeral 606, the device can generate traffic data indicative of bi-directional traffic flows between the first network edge device and the second network edge device that resulted from the client device executing the specified application. In other words, the traffic data can act as a record of actual traffic flows that arise from use of the specified application, which can be anonymized and replayed to test how that specified application performs in a different (e.g., upgraded) network environment. Method 600 can stop or proceed to insert A, which is further detailed in connection with FIG. 7.

With reference now to FIG. 7, exemplary method 700 is illustrated. Method 700 can provide for additional elements or aspects in connection with the record procedure that can record application flows from a specific application in accordance with certain embodiments of this disclosure. For example, at reference numeral 702, the device can receive an indication that network equipment of the software defined network is to undergo a change determined to potentially affect operation of the specified application and, in response to the receiving, performing the generating of the traffic data. Put differently, the record procedure can be triggered or initiated in response to an indication that a network change or update is to be performed.

At reference numeral 704, the device can format the traffic data as an exportable file comprising anonymized payload data, anonymized header data, and playback timing derived from timestamps of the bi-directional traffic flows. In some embodiments, the playback timing can be stored as metadata.

At reference numeral 706, the device can perform a playback procedure. The playback procedure can be performed in response to a change to the software defined network (e.g., a network upgrade). The playback procedure can generate anonymized bi-directional traffic flows representative of the bi-directional traffic flows represented by the traffic data. Timing data indicative of timestamps for any given hop can be utilized for the replay and can also be utilized for performance comparisons.

### Example Operating Environments

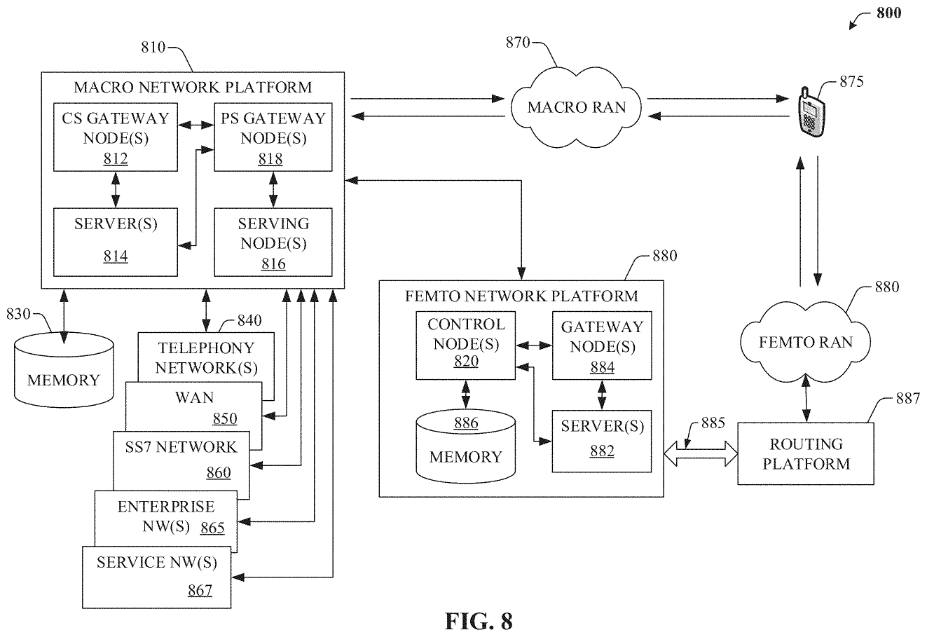

To provide further context for various aspects of the subject specification, FIG. 8 illustrates an example wireless communication environment 800, with associated components that can enable operation of a femtocell enterprise network in accordance with aspects described herein. Wireless communication environment 800 comprises two wireless network platforms: (i) A macro network platform 810 that serves, or facilitates communication with, user equipment 875 via a macro radio access network (RAN) 870. It should be appreciated that in cellular wireless technologies (e.g., 4G, 3GPP UMTS, HSPA, 3GPP LTE, 3GPP UMB, 5G), macro network platform 810 is embodied in a Core Network. (ii) A femto network platform 880, which can provide communication with UE 875 through a femto RAN 890, linked to the femto network platform 880 through a routing platform 887 via backhaul pipe(s) 885. It should be appreciated that femto network platform 880 typically offloads UE 875 from macro network, once UE 875 attaches (e.g., through macro-to-femto handover, or via a scan of channel resources in idle mode) to femto RAN.

It is noted that RAN comprises base station(s), or access point(s), and its associated electronic circuitry and deployment site(s), in addition to a wireless radio link operated in accordance with the base station(s). Accordingly, macro RAN1370 can comprise various coverage cells, while femto RAN 890 can comprise multiple femto access points or multiple metro cell access points. As mentioned above, it is to be appreciated that deployment density in femto RAN 890 can be substantially higher than in macro RAN 870.

Generally, both macro and femto network platforms 810 and 880 comprise components, e.g., nodes, gateways, interfaces, servers, or platforms, that facilitate both packet-switched (PS) (e.g., internet protocol (IP), Ethernet, frame relay, asynchronous transfer mode (ATM)) and circuit-switched (CS) traffic (e.g., voice and data) and control generation for networked wireless communication. In an aspect of the subject innovation, macro network platform 810 comprises CS gateway node(s) 812 which can interface CS traffic received from legacy networks like telephony network(s) 840 (e.g., public switched telephone network (PSTN), or public land mobile network (PLMN)) or a SS7 network 860. Circuit switched gateway 812 can authorize and authenticate traffic (e.g., voice) arising from such networks. Additionally, CS gateway 812 can access mobility, or roaming, data generated through SS7 network 860; for instance, mobility data stored in a VLR, which can reside in memory 830. Moreover, CS gateway node(s) 812 interfaces CS-based traffic and signaling and gateway node(s) 818. As an example, in a 3GPP UMTS network, gateway node(s) 818 can be embodied in gateway GPRS support node(s) (GGSN).

In addition to receiving and processing CS-switched traffic and signaling, gateway node(s) 818 can authorize and authenticate PS-based data sessions with served (e.g., through macro RAN) wireless devices. Data sessions can comprise traffic exchange with networks external to the macro network platform 810, like wide area network(s) (WANs) 850; it should be appreciated that local area network(s) (LANs) can also be interfaced with macro network platform 810 through gateway node(s) 818. Gateway node(s) 818 generates packet data contexts when a data session is established. To that end, in an aspect, gateway node(s) 818 can comprise a tunnel interface (e.g., tunnel termination gateway (TTG) in 3GPP UMTS network(s); not shown) which can facilitate packetized communication with disparate wireless network(s), such as Wi-Fi networks. It should be further appreciated that the packetized communication can comprise multiple flows that can be generated through server(s) 814. It is to be noted that in 3GPP UMTS network(s), gateway node(s) 818 (e.g., GGSN) and tunnel interface (e.g., TTG) comprise a packet data gateway (PDG).

Macro network platform 810 also comprises serving node(s) 816 that convey the various packetized flows of information or data streams, received through gateway node(s) 818. As an example, in a 3GPP UMTS network, serving node(s) can be embodied in serving GPRS support node(s) (SGSN).

As indicated above, server(s) 814 in macro network platform 810 can execute numerous applications (e.g., location services, online gaming, wireless banking, wireless device management . . . ) that generate multiple disparate packetized data streams or flows, and manage (e.g., schedule, queue, format . . . ) such flows. Such application(s), for example can comprise add-on features to standard services provided by macro network platform 810. Data streams can be conveyed to gateway node(s) 818 for authorization/authentication and initiation of a data session, and to serving node(s) 816 for communication thereafter. Server(s) 814 can also effect security (e.g., implement one or more firewalls) of macro network platform 810 to ensure network's operation and data integrity in addition to authorization and authentication procedures that CS gateway node(s) 812 and gateway node(s) 818 can enact. Moreover, server(s) 814 can provision services from external network(s), e.g., WAN 850, or Global Positioning System (GPS) network(s) (not shown). It is to be noted that server(s) 814 can comprise one or more processor configured to confer at least in part the functionality of macro network platform 810. To that end, the one or more processor can execute code instructions stored in memory 830, for example.

In example wireless environment 800, memory 830 stores information related to operation of macro network platform 810. Information can comprise business data associated with subscribers; market plans and strategies, e.g., promotional campaigns, business partnerships; operational data for mobile devices served through macro network platform; service and privacy policies; end-user service logs for law enforcement; and so forth. Memory 830 can also store information from at least one of telephony network(s) 840, WAN(s) 850, or SS7 network 860, enterprise NW(s) 865, or service NW(s) 867.

Femto gateway node(s) 884 have substantially the same functionality as PS gateway node(s) 818. Additionally, femto gateway node(s) 884 can also comprise substantially all functionality of serving node(s) 816. In an aspect, femto gateway node(s) 884 facilitates handover resolution, e.g., assessment and execution. Further, control node(s) 820 can receive handover requests and relay them to a handover component (not shown) via gateway node(s) 884. According to an aspect, control node(s) 820 can support RNC capabilities.

Server(s) 882 have substantially the same functionality as described in connection with server(s) 814. In an aspect, server(s) 882 can execute multiple application(s) that provide service (e.g., voice and data) to wireless devices served through femto RAN 890. Server(s) 882 can also provide security features to femto network platform. In addition, server(s) 882 can manage (e.g., schedule, queue, format . . . ) substantially all packetized flows (e.g., IP-based) it generates in addition to data received from macro network platform 810. It is to be noted that server(s) 882 can comprise one or more processor configured to confer at least in part the functionality of macro network platform 810. To that end, the one or more processor can execute code instructions stored in memory 886, for example.

Memory 886 can comprise information relevant to operation of the various components of femto network platform 880. For example, operational information that can be stored in memory 886 can comprise, but is not limited to, subscriber information; contracted services; maintenance and service records; femto cell configuration (e.g., devices served through femto RAN 890; access control lists, or white lists); service policies and specifications; privacy policies; add-on features; and so forth.

It is noted that femto network platform 880 and macro network platform 810 can be functionally connected through one or more reference link(s) or reference interface(s). In addition, femto network platform 880 can be functionally coupled directly (not illustrated) to one or more of external network(s) 840, 850, 860, 865 or 867. Reference link(s) or interface(s) can functionally link at least one of gateway node(s) 884 or server(s) 886 to the one or more external networks 840, 850, 860, 865 or 867.

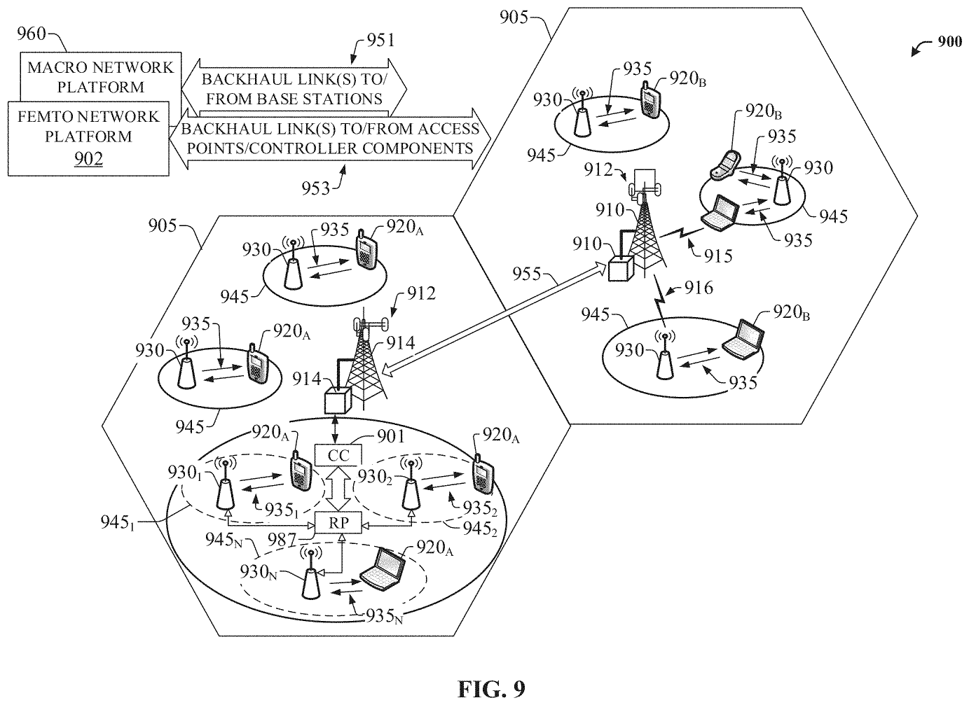

FIG. 9 illustrates a wireless environment that comprises macro cells and femtocells for wireless coverage in accordance with aspects described herein. In wireless environment 905, two areas represent “macro” cell coverage; each macro cell is served by a base station 910. It can be appreciated that macro cell coverage area 905 and base station 910 can comprise functionality, as more fully described herein, for example, with regard to system 900. Macro coverage is generally intended to serve mobile wireless devices, like UE 920_{A}, 920_{B}, in outdoors locations. An over-the-air (OTA) wireless link 935 provides such coverage, the wireless link 935 comprises a downlink (DL) and an uplink (UL), and utilizes a predetermined band, licensed or unlicensed, of the radio frequency (RF) spectrum. As an example, UE 920_{A}, 920_{B} can be a 3GPP Universal Mobile Telecommunication System (UMTS) mobile phone. It is noted that a set of base stations, its associated electronics, circuitry or components, base stations control component(s), and wireless links operated in accordance to respective base stations in the set of base stations form a radio access network (RAN). In addition, base station 910 communicates via backhaul link(s) 951 with a macro network platform 960, which in cellular wireless technologies (e.g., 3rd Generation Partnership Project (3GPP) Universal Mobile Telecommunication System (UMTS), Global System for Mobile Communication (GSM)) represents a core network.

In an aspect, macro network platform 960 controls a set of base stations 910 that serve either respective cells or a number of sectors within such cells. Base station 910 comprises radio equipment 914 for operation in one or more radio technologies, and a set of antennas 912 (e.g., smart antennas, microwave antennas, satellite dish(es) . . . ) that can serve one or more sectors within a macro cell 905. It is noted that a set of radio network control node(s), which can be a part of macro network platform 960; a set of base stations (e.g., Node B 910) that serve a set of macro cells 905; electronics, circuitry or components associated with the base stations in the set of base stations; a set of respective OTA wireless links (e.g., links 915 or 916) operated in accordance to a radio technology through the base stations; and backhaul link(s) 955 and 951 form a macro radio access network (RAN). Macro network platform 960 also communicates with other base stations (not shown) that serve other cells (not shown). Backhaul link(s) 951 or 953 can comprise a wired backbone link (e.g., optical fiber backbone, twisted-pair line, T1/E1 phone line, a digital subscriber line (DSL) either synchronous or asynchronous, an asymmetric ADSL, or a coaxial cable . . . ) or a wireless (e.g., LoS or non-LoS) backbone link. Backhaul pipe(s) 955 link disparate base stations 910. According to an aspect, backhaul link 953 can connect multiple femto access points 930 and/or controller components (CC) 901 to the femto network platform 902. In one example, multiple femto APs can be connected to a routing platform (RP) 987, which in turn can be connect to a controller component (CC) 901. Typically, the information from UEs 920_{A} can be routed by the RP 987, for example, internally, to another UE 920_{A} connected to a disparate femto AP connected to the RP 987, or, externally, to the femto network platform 902 via the CC 901, as discussed in detail supra.

In wireless environment 905, within one or more macro cell(s) 905, a set of femtocells 945 served by respective femto access points (APs) 930 can be deployed. It can be appreciated that, aspects of the subject innovation can be geared to femtocell deployments with substantive femto AP density, e.g., 9⁴-10⁷ femto APs 930 per base station 910. According to an aspect, a set of femto access points 930₁-930_{N}, with N a natural number, can be functionally connected to a routing platform 987, which can be functionally coupled to a controller component 901. The controller component 901 can be operationally linked to the femto network platform 902 by employing backhaul link(s) 953. Accordingly, UE 920_{A} connected to femto APs 930₁-930_{N} can communicate internally within the femto enterprise via the routing platform (RP) 987 and/or can also communicate with the femto network platform 902 via the RP 987, controller component 901 and the backhaul link(s) 953. It can be appreciated that although only one femto enterprise is depicted in FIG. 9, multiple femto enterprise networks can be deployed within a macro cell 905.

It is noted that while various aspects, features, or advantages described herein have been illustrated through femto access point(s) and associated femto coverage, such aspects and features also can be exploited for home access point(s) (HAPs) that provide wireless coverage through substantially any, or any, disparate telecommunication technologies, such as for example Wi-Fi (wireless fidelity) or picocell telecommunication. Additionally, aspects, features, or advantages of the subject innovation can be exploited in substantially any wireless telecommunication, or radio, technology; for example, Wi-Fi, Worldwide Interoperability for Microwave Access (WiMAX), Enhanced General Packet Radio Service (Enhanced GPRS), 3GPP LTE, 3GPP2 UMB, 3GPP UMTS, HSPA, HSDPA, HSUPA, or LTE Advanced. Moreover, substantially all aspects of the subject innovation can comprise legacy telecommunication technologies.

With respect to FIG. 9, in example embodiment 900, base station AP 910 can receive and transmit signal(s) (e.g., traffic and control signals) from and to wireless devices, access terminals, wireless ports and routers, etc., through a set of antennas 912₁-912_{N}. It should be appreciated that while antennas 912₁-912_{N} are a part of communication platform 925, which comprises electronic components and associated circuitry that provides for processing and manipulating of received signal(s) (e.g., a packet flow) and signal(s) (e.g., a broadcast control channel) to be transmitted. In an aspect, communication platform 925 comprises a transmitter/receiver (e.g., a transceiver) 966 that can convert signal(s) from analog format to digital format upon reception, and from digital format to analog format upon transmission. In addition, receiver/transmitter 966 can divide a single data stream into multiple, parallel data streams, or perform the reciprocal operation. Coupled to transceiver 966 is a multiplexer/demultiplexer 967 that facilitates manipulation of signal in time and frequency space. Electronic component 967 can multiplex information (data/traffic and control/signaling) according to various multiplexing schemes such as time division multiplexing (TDM), frequency division multiplexing (FDM), orthogonal frequency division multiplexing (OFDM), code division multiplexing (CDM), space division multiplexing (SDM). In addition, mux/demux component 967 can scramble and spread information (e.g., codes) according to substantially any code known in the art; e.g., Hadamard-Walsh codes, Baker codes, Kasami codes, polyphase codes, and so on. A modulator/demodulator 968 is also a part of operational group 925, and can modulate information according to multiple modulation techniques, such as frequency modulation, amplitude modulation (e.g., M-ary quadrature amplitude modulation (QAM), with M a positive integer), phase-shift keying (PSK), and the like.

Referring now to FIG. 10, there is illustrated a block diagram of an exemplary computer system operable to execute the disclosed architecture. In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This comprises at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE802.3 or Ethernet). Wi-Fi networks operate in the unlicensed 2.4 and 5 GHz radio bands, at an 11 Mbps (802.11b) or 54 Mbps (802.11a) data rate, for example, or with products that contain both bands (dual band), so the networks can provide real-world performance similar to the basic “10BaseT” wired Ethernet networks used in many offices.

What has been described above comprises examples of the various embodiments. It is, of course, not possible to describe every conceivable combination of components or methodologies for purposes of describing the embodiments, but one of ordinary skill in the art may recognize that many further combinations and permutations are possible. Accordingly, the detailed description is intended to embrace all such alterations, modifications, and variations that fall within the spirit and scope of the appended claims.

As used in this application, the terms “system,” “component,” “interface,” and the like are generally intended to refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. These components also can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry that is operated by software or firmware application(s) executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. An interface can comprise input/output (I/O) components as well as associated processor, application, and/or API components.

Furthermore, the disclosed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from by a computing device.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor also can be implemented as a combination of computing processing units.

In the subject specification, terms such as “store,” “data store,” “data storage,” “database,” “repository,” “queue”, and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory. In addition, memory components or memory elements can be removable or stationary. Moreover, memory can be internal or external to a device or component, or removable or stationary. Memory can comprise various types of media that are readable by a computer, such as hard-disc drives, zip drives, magnetic cassettes, flash memory cards or other types of memory cards, cartridges, or the like.

By way of illustration, and not limitation, nonvolatile memory can comprise read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments comprise a system as well as a computer-readable medium having computer-executable instructions for performing the acts and/or events of the various methods.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communications media comprise wired media, such as a wired network or direct-wired connection, and wireless media such as acoustic, RF, infrared and other wireless media

Further, terms like “user equipment,” “user device,” “mobile device,” “mobile,” station,” “access terminal,” “terminal,” “handset,” and similar terminology, generally refer to a wireless device utilized by a subscriber or user of a wireless communication network or service to receive or convey data, control, voice, video, sound, gaming, or substantially any data-stream or signaling-stream. The foregoing terms are utilized interchangeably in the subject specification and related drawings. Likewise, the terms “access point,” “node B,” “base station,” “evolved Node B,” “cell,” “cell site,” and the like, can be utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows. It is noted that in the subject specification and drawings, context or explicit distinction provides differentiation with respect to access points or base stations that serve and receive data from a mobile device in an outdoor environment, and access points or base stations that operate in a confined, primarily indoor environment overlaid in an outdoor coverage area. Data and signaling streams can be packetized or frame-based flows.

Furthermore, the terms “user,” “subscriber,” “customer,” “consumer,” and the like are employed interchangeably throughout the subject specification, unless context warrants particular distinction(s) among the terms. It should be appreciated that such terms can refer to human entities, associated devices, or automated components supported through artificial intelligence (e.g., a capacity to make inference based on complex mathematical formalisms) which can provide simulated vision, sound recognition and so forth. In addition, the terms “wireless network” and “network” are used interchangeable in the subject application, when context wherein the term is utilized warrants distinction for clarity purposes such distinction is made explicit.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

In addition, while a particular feature may have been disclosed with respect to only one of several implementations, such feature may be combined with one or more other features of the other implementations as may be desired and advantageous for any given or particular application. Furthermore, to the extent that the terms “includes” and “including” and variants thereof are used in either the detailed description or the claims, these terms are intended to be inclusive in a manner similar to the term “comprising.”

1. A device, comprising:
a processor; and
a memory that stores executable instructions that, when executed by the processor, facilitate performance of operations, the operations comprising:
identifying an application that, when executed, generates application data that is communicated between a user equipment and a service device associated with a service provider identity of an application service provider;
selecting first network edge equipment in response to a determination that a first condition is satisfied, satisfaction of the first condition being that the first network edge equipment facilitates first network access to the user equipment by communicating first traffic flows comprising the application data generated during execution of the application;
selecting second network edge equipment in response to a determination that a second condition is satisfied, satisfaction of the second condition being that the second network edge equipment facilitates second network access to the service device by communicating second traffic flows comprising the application data generated during execution of the application; and
generating record data, comprising:
first record data that represents defined characteristics of the first traffic flows comprising the application data that is communicated from the user equipment to the service device in response to execution of the application; and
second record data that represents defined characteristics of the second traffic flows comprising the application data that is communicated from the service device to the user equipment in response to execution of the application.

2. The device of claim 1, wherein the first network edge equipment and the second network edge equipment are part of a software defined network.

3. The device of claim 2, wherein the generating of the record data is in response to receiving an indication that the software defined network is to undergo an upgrade that is determined to affect operation of the application.

4. The device of claim 2, wherein the generating of the record data comprises:
instructing, via a software defined network controller, the first network edge equipment to record the first traffic flows from the second network edge equipment as first record flow data; and
instructing, via the software defined network controller, the second network edge equipment to record the second traffic flows from the first network edge equipment as second traffic flow data.

5. The device of claim 4, wherein the software defined network controller receives and combines the first record flow data and the second record flow data, resulting in a representation of bi-directional traffic flows between the first network edge equipment and the second network edge equipment that were determined to respectively facilitate access to the user equipment and the service device during execution of the application that is determined to be generated prior to an upgrade.

6. The device of claim 1, wherein the record data comprises payload size data indicative of a size of payload data of bi-directional traffic flows between the first network edge equipment and the second network edge equipment that were determined to respectively facilitate access to the user equipment and the service device during execution of the application that is determined to be generated prior to an upgrade to the first network edge equipment.

7. The device of claim 1, wherein the record data comprises timestamp data indicative of a timing applicable to bi-directional traffic flows between the first network edge equipment and the second network edge equipment that were determined to respectively facilitate access to the user equipment and the service device during execution of the application that is determined to be generated prior to an upgrade to the first network edge equipment.

8. The device of claim 1, wherein the operations further comprise replacing identifier data that is part of bi-directional traffic flows with anonymized identifier data, and wherein the identifier data is determined to be generated prior to an upgrade to the first network edge equipment.

9. The device of claim 1, wherein the record data is configured as an exportable file.

10. The device of claim 1, wherein the operations further comprise determining the application in response to identifying a target application having at least a determined significance according to a defined significance criterion.

11. The device of claim 1, wherein the operations further comprise:
in response to a determination that a network upgrade has been performed, importing the record data to a network environment to which the network upgrade has been applied; and
executing a playback procedure, via the network environment, that instructs the first network edge equipment and the second network edge equipment to play back the record data, resulting in simulated bi-directional traffic flows that are specific to the application, wherein the simulated bi-directional traffic flows has a payload size indicated by the record data and a first payload of dummy data that differs from a second payload of the application data.

12. The device of claim 11, wherein the operations further comprise monitoring the playback procedure to determine whether the network upgrade changes a performance of the application relative to a previous performance of the application measured prior to the network upgrade.

13. A non-transitory machine-readable medium, comprising executable instructions that, when executed by a processor, facilitate performance of operations, comprising:
identifying an application that, when executed, generates application data that is communicated between a user equipment and a service equipment associated with a service provider identity of an application service provider;
determining first network edge equipment, of a software defined network, in response to a determination that a first condition is present, the first condition being that the first network edge equipment facilitates enabling first network access for a subscriber device by communicating first traffic flows comprising the application data generated during execution of the application;
determining second network edge equipment, of the software defined network, in response to a determination that a second condition is present, the second condition being that the first network edge equipment facilitates enabling second network access for the service equipment by communicating second traffic flows comprising the application data generated during execution of the application; and
generating record data having defined attributes of bi-directional traffic flows, comprising the first traffic flows and the second traffic flows, between the first network edge equipment and the second network edge equipment that result from the subscriber device executing the application.

14. The non-transitory machine-readable medium of claim 13, wherein the generating of the record data is in response to receiving an indication that the software defined network is to undergo a change that is determined to potentially change an operation of the application.

15. The non-transitory machine-readable medium of claim 13, wherein the operations further comprise identifying the application based on a result of an application identification procedure that identifies a target application as having a defined characteristic that satisfies an importance criterion relative to a threshold level of importance of the application functioning satisfactorily following an upgrade to the software defined network.

16. The non-transitory machine-readable medium of claim 13, wherein the operations further comprise formatting the record data as an exportable file comprising anonymized payload data, anonymized header data, and playback timing that corresponds to timing recorded from the bi-directional traffic flows prior to an upgrade to the software defined network.

17. A method, comprising:
identifying, by a device comprising a processor, a specified application that, when executed, generates application data that is communicated between a client device and a service device associated with a service provider identity of an application service provider;
determining, by the device, a first network edge device, of a software defined network, in response to a determination that a first condition is satisfied, the first condition being satisfied being that the first network edge equipment facilitates network access for the client device by communicating first traffic flows comprising the application data generated during execution of the specified application;
determining, by the device, a second network edge device, of the software defined network, in response to a determination that a second condition is satisfied, the second condition being satisfied being that the first network edge equipment facilitates the network access for the service device by communicating second traffic flows comprising the application data generated during execution of the specified application; and
generating, by the device, record data indicative of defined characteristics of bi-directional traffic flows, comprising the first traffic flows and the second traffic flows, between the first network edge device and the second network edge device that resulted from the client device executing the specified application.

18. The method of claim 17, further comprising receiving, by the device, an indication that network equipment of the software defined network is to undergo a change determined to potentially affect operation of the specified application and, in response to the receiving, generating of the record data.

19. The method of claim 17, further comprising formatting, by the device, the record data as an exportable file comprising anonymized payload data, anonymized header data, and playback timing derived from timestamps of the bi-directional traffic flows.

20. The method of claim 19, further comprising, performing, by the device, a playback procedure in response to a change to the software defined network, wherein the playback procedure generates anonymized bi-directional traffic flows representative of the bi-directional traffic flows represented by the record data that was generated prior to an upgrade to the software defined network.
